(19) United States
(12) Patent Application Publication
(10) Pub. No.: US 2010/0086691 A1
(43) Pub. Date: Apr. 8, 2010

(54) PRINTING METHOD EMPLOYING INK JET RECORDING TECHNIQUE

(75) Inventors: Hiroshi MUKAI, Shiojiri-shi (JP); Katsuko AOKI, Nagano-ken (JP)

Correspondence Address: LADAS & PARRY, 26 West 61st Street, New York, NY, 10023, US

(73) Assignee: SEIKO EPSON CORPORATION

(21) Appl. No.: 12/575,052

(22) Filed: Oct. 7, 2009

(30) Foreign Application Priority Data
Oct. 8, 2008 (JP) 2008-261375

(51) Int. Cl. B05D 5/00

(52) U.S. Cl. 427/256

(57) ABSTRACT

A printing method employing an ink jet recording technique includes: forming an image with an ink jet recording technique by ejecting droplets of a water-based ink composition onto a recording medium having no or low ink absorbency; and drying the water-based ink composition on the recording medium, the drying being conducted so as to at least overlap the forming. The water-based ink composition contains at least one selected from N-methyl-2-pyrrolidone, tetramethylurea, and dimethyl sulfoxide; a water-insoluble coloring agent; a water-soluble resin; thermoplastic resin particles; a silicone-based surfactant; an acetylene glycol-based surfactant; a penetrating agent; a moisture retaining agent; and water. The total content of the N-methyl-2-pyrrolidone, the tetramethylurea, and the dimethyl sulfoxide in the water-based ink composition is 3.0 to 10.0 mass %. The content of the penetrating agent in the water-based ink composition is 3.0 to 8.0 mass %. The content of the moisture retaining agent in the water-based ink composition is 5.0 to 10.0 mass %.

### BACKGROUND

1. Technical Field

The present invention relates to a printing method employing an ink jet recording technique.

2. Related Art

Solvent-based pigment inks have been used for recording media having no ink absorbency such as vinyl chloride-based substrates. Solvent-based pigment inks have an excellent drying property and excellent resistance to water. However, images are formed as a result of evaporation of solvents from such inks on the surfaces of recording media, odor and toxicity of solvents upon drying of inks have been problematic. Accordingly, in view of safety and environmental friendliness, water-based inks have come to be used even for recording media having no or low ink absorbency.

Printing methods for forming an image with a water-based ink by an ink jet recording technique on a recording medium having no or low ink absorbency are described in, for example, the following patent documents. JP-A-2000-44858 proposes a method of printing an image on a hydrophobic surface with an ink that contains water, a glycol-based solvent, an insoluble coloring agent, a polymeric dispersing agent, a silicon surfactant, a fluorinated surfactant, a water-insoluble graft copolymer binder, and N-methylpyrrolidone. JP-A-2005-220352 proposes a polymer colloid-containing water-based ink jet ink used for printing on non-porous substrates, the ink containing a water-based liquid vehicle containing a volatile co-solvent having a boiling point of 285° C. or less, acid-functionalized polymer colloid particles, and a pigment coloring agent.

However, inks having been proposed so far contain large amounts of solvents having relatively high boiling points, and hence, such inks dry slowly upon printing and undesired phenomena such as mixing of inks on recording media occur. Thus, printed products of high image quality are not necessarily obtained. Additionally, inks having been proposed so far contain large amounts of solvents having relatively high boiling points, and such solvents remain in printed products, resulting in poor abrasion resistance of the printed products.

### SUMMARY

An advantage of some aspects of the invention is that a printing method employing an ink jet recording technique is provided in which an image is formed on a recording medium having no or low ink absorbency by the ink jet recording technique with a water-based ink composition, and the resultant image is of high quality and has less blurring of ink and excellent resistance to abrasion.

A printing method employing an ink jet recording technique according to an aspect of the invention includes: forming an image with an ink jet recording technique by ejecting droplets of a water-based ink composition onto a recording medium having no or low ink absorbency; and drying the water-based ink composition on the recording medium, the drying being conducted so as to at least overlap the forming. The water-based ink composition contains at least one selected from N-methyl-2-pyrrolidone, tetramethylurea, and dimethyl sulfoxide; a water-insoluble coloring agent; a water-soluble resin; thermoplastic resin particles; a silicone-based surfactant; an acetylene glycol-based surfactant; a penetrating agent; a moisture retaining agent; and water. A total content of the N-methyl-2-pyrrolidone, the tetramethylurea, and the dimethyl sulfoxide in the water-based ink composition is 3.0 to 10.0 mass %. A content of the penetrating agent in the water-based ink composition is 3.0 to 8.0 mass %. A content of the moisture retaining agent in the water-based ink composition is 5.0 to 10.0 mass %.

In the printing method employing an ink jet recording technique, the drying preferably includes at least one of heating the recording medium to the range of 40° C. to 80° C. and blowing air in the range of 40° C. to 80° C. to the water-based ink composition on the recording medium.

In the printing method employing an ink jet recording technique, the thermoplastic resin particles preferably swell or dissolve in at least one selected from N-methyl-2-pyrrolidone, tetramethylurea, and dimethyl sulfoxide serving as a solvent.

In the printing method employing an ink jet recording technique, the penetrating agent is preferably 1,2-hexanediol.

In the printing method employing an ink jet recording technique, the moisture retaining agent is preferably propylene glycol.

In the printing method employing an ink jet recording technique, the water-based ink composition preferably has a viscosity in the range of 1.5 to 15 mPa·s at 20° C.

In the printing method employing an ink jet recording technique, a content of the silicone-based surfactant in the water-based ink composition is preferably 0.1 to 1.5 mass %.

In the printing method employing an ink jet recording technique, a content of the acetylene glycol-based surfactant in the water-based ink composition is preferably 0.1 to 1.0 mass %.

### DESCRIPTION OF EXEMPLARY EMBODIMENTS

Hereinafter, preferred embodiments according to the present invention are described in detail.

### 1. Printing Method Employing Ink Jet Recording Technique

A printing method employing an ink jet recording technique according to an embodiment includes a first step of forming an image with an ink jet recording technique by ejecting droplets of a water-based ink composition onto a recording medium having no or low ink absorbency; and a second step of drying the water-based ink composition on the recording medium, the second step being conducted so as to at least overlap the first step. The water-based ink composition contains at least one selected from N-methyl-2-pyrrolidone, tetramethylurea, and dimethyl sulfoxide; a water-insoluble coloring agent; a water-soluble resin; thermoplastic resin particles; a silicone-based surfactant; an acetylene glycol-based surfactant; a penetrating agent; a moisture retaining agent; and water. The total content of the N-methyl-2-pyrrolidone, the tetramethylurea, and the dimethyl sulfoxide in the water-based ink composition is 3.0 to 10.0 mass %. The content of the penetrating agent in the water-based ink composition is 3.0 to 8.0 mass %. The content of the moisture retaining agent in the water-based ink composition is 5.0 to 10.0 mass %.

First, a water-based ink composition used in a printing method employing an ink jet recording technique according to the present embodiment will be described below.

### 1. 1. Water-Based Ink Composition

1. 1. 1. At Least One Selected from N-methyl-2-pyrrolidone, Tetramethylurea, and Dimethyl Sulfoxide

A water-based ink composition used in a printing method according to the present embodiment contains at least one selected from N-methyl-2-pyrrolidone, tetramethylurea, and dimethyl sulfoxide. N-methyl-2-pyrrolidone, tetramethylurea, and dimethyl sulfoxide function as a good solubilizer, a good swelling agent, or a good softener for thermoplastic resin particles contained in the water-based ink composition. N-methyl-2-pyrrolidone, tetramethylurea, and dimethyl sulfoxide also have a function to promote the formation of a film of a water-soluble resin contained in the water-based ink composition when ink is being dried, to thereby promote solidification and fixing of the ink on recording media having no or low ink absorbency. N-methyl-2-pyrrolidone, tetramethylurea, and dimethyl sulfoxide respectively have boiling points of 202° C., 177.5° C., and 189° C. The total content of N-methyl-2-pyrrolidone, tetramethylurea, and dimethyl sulfoxide is 3.0 to 10.0 mass based on the entire amount of the water-based ink composition. When the total content of N-methyl-2-pyrrolidone, tetramethylurea, and dimethyl sulfoxide is less than 3.0 mass %, there is a possibility that a water-insoluble coloring agent and thermoplastic resin particles are not sufficiently dispersed in the water-based ink composition, and the water-based ink composition does not have sufficiently high storage stability. In contrast, when the total content of N-methyl-2-pyrrolidone, tetramethylurea, and dimethyl sulfoxide is more than 10.0 mass %, there is a possibility that the drying rate of a printed product during or after printing is low and undesired mixing of ink occurs on a recording medium, which results in, for example, a poor tone and poor image quality.

An example of a compound that can be used instead of N-methyl-2-pyrrolidone is N-ethyl-2-pyrrolidone, N-vinyl-2-pyrrolidone, N-butyl-2-pyrrolidone, 5-methyl-2-pyrrolidone, or the like.

### 1. 1. 2. Coloring Agent

A water-based ink composition used in a printing method according to the present embodiment further contains a water-insoluble coloring agent. Such a water-insoluble coloring agent may be a water-insoluble dye or a pigment, and is preferably a pigment. This is because pigments are insoluble or slightly soluble in water and also have resistance to discoloration due to light, gas, or the like; and hence, recorded products obtained by printing with an ink composition containing a pigment are excellent in terms of water resistance, gas resistance, light resistance, or the like and have good storage stability.

Such a pigment may be a known inorganic pigment, a known organic pigment, or carbon black. Of these, carbon black and an organic pigment are preferable because they provide good color development, and they have small specific gravity and are less prone to sediment when being dispersed.

Specific preferred examples of carbon black for the invention include: furnace black, lamp black, acetylene black, channel black, and the like (C.I. Pigment Black 7); for commercially available products, No. 2300, 900, MCF88, No. 20B, No. 33, No. 40, No. 45, No. 52, MA7, MA8, MA100, No. 2200B, and the like (all of which are names of products manufactured by Mitsubishi Chemical Corporation); COLOUR BLACK FW1, FW2, FW2V, FW18, FW200, 5150, 5160, 5170, PRINTEX 35, U, V, 140U, SPECIAL BLACK 6, 5, 4A, 4, 250, and the like (all of which are names of products manufactured by Degussa Japan Co., Ltd.); Conductex SC, Raven 1255, 5750, 5250, 5000, 3500, 1255, 700, and the like (all of which are names of products manufactured by Columbian Carbon Company); REGAL 400R, 330R, 660R, MOGUL L, MONARCH 700, 800, 880, 900, 1000, 1100, 1300, 1400, ELFTEX 12, and the like (all of which are names of products manufactured by Cabot Corporation). These listed are preferred examples of carbon black for the invention and are not intended to restrict the invention. These carbon blacks may be used alone or as a mixture of two or more thereof. The content of such carbon black/carbon blacks is 0.5 to 20 mass %, preferably 1 to 10 mass %, based on the entire amount of the black ink composition.

Preferred organic pigments for the invention are quinacridon-based pigments, quinacridon quinone-based pigments, dioxazine-based pigments, phthalocyanine-based pigments, anthrapyrimidine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, isoindolinone-based pigments, azomethine-based pigments, azo-based pigments, and the like.

Specific examples of organic pigments used for a water-based ink composition according to the invention are described below.

Examples of a pigment used for a cyan ink composition are C.I. Pigment Blue 1, 2, 3, 15:3, 15:4, 15:34, 16, 22, 60, and the like; C.I. Vat Blue 4, 60, and the like. Preferably, one or a mixture of two or more selected from the group consisting of C.I. Pigment Blue 15:3, 15:4, and 60 is used. The content of such a pigment/pigments is about 0.5 to 20 mass %, preferably about 1 to 10 mass %, based on the entire amount of the cyan ink composition.

Examples of a pigment used for a magenta ink composition are C.I. Pigment Red 5, 7, 12, 48 (Ca), 48 (Mn), 57 (Ca), 57:1, 112, 122, 123, 168, 184, 202, C.I. Pigment Violet 19, and the like. Preferably, one or a mixture of two or more selected from the group consisting of C.I. Pigment Red 122, 202, 209, and C.I. Pigment Violet 19 is used. The content of such a pigment/pigments is about 0.5 to 20 mass %, preferably about 1 to 10 mass %, based on the entire amount of the magenta ink composition.

Examples of a pigment used for a yellow ink composition are C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like. Preferably, one or a mixture of two or more selected from the group consisting of C.I. Pigment Yellow 74, 109, 110, 128, 138, 180, and 185 is used. The content of such a pigment/pigments is about 0.5 to 20 mass %, preferably about 1 to 10 mass %, based on the entire amount of the yellow ink composition.

Examples of a pigment used for an orange ink composition are C.I. Pigment Orange 36, 43, and a mixture of the foregoing. The content of such a pigment/pigments is about 0.5 to 20 mass %, preferably about 1 to 10 mass %, based on the entire amount of the orange ink composition.

Examples of a pigment used for a green ink composition are C.I. Pigment Green 7, 36, and a mixture of the foregoing. The content of such a pigment/pigments is about 0.5 to 20 mass %, preferably about 1 to 10 mass %, based on the entire amount of the green ink composition.

To make the above-described pigments to be maintained more stably in the state of being dispersed in a water-based ink composition, the pigments may be processed by various techniques. An example of such a technique is, a technique of dispersing a pigment with a resin dispersing agent, a technique of dispersing a pigment with a surfactant, a technique of chemically/physically introducing hydrophilic functional groups to the surfaces of pigment particles to thereby make the pigment particles capable of being dispersed and/or dissolved, or the like. Any one of these techniques may be used and, if necessary, these techniques may be used in combination, for a water-based ink composition used in a printing method according to the present embodiment. A water-based ink composition according to the present embodiment contains a water-soluble resin described below and the water-soluble resin also functions as such a resin dispersing agent. For this reason, description of the technique of using a resin dispersing agent is omitted.

Examples of a surfactant that may be used for dispersing a pigment include: anionic surfactants such as alkane sulfonates, α-olefin sulfonates, alkylbenzene sulfonates, alkylnaphthalenesulfonates, acylmethyl taurate, dialkyl sulfosuccinates, alkyl sulfates, sulfated olefins, polyoxyethylene alkyl ether sulfates, alkyl phosphates, polyoxyethylene alkyl ether phosphates, and monoglyceride phosphates; ampholytic surfactants such as alkyl pyridium salts, alkyl amino acid salts, and alkyl dimethyl betaines; and nonionic surfactants such as polyoxyethylene alkyl ethers, polyoxyethylene alkyl phenyl ethers, polyoxyethylene alkyl esters, polyoxyethylene alkyl amides, glycerin alkyl esters, and sorbitan alkyl esters.

The amount of the resin dispersing agent or the surfactant to be added to a pigment is preferably 1 to 100 mass %, more preferably, 5 to 50 mass %, based on 1 mass % of the pigment. Satisfying these ranges can ensure sufficiently high dispersion stability of a pigment in water.

For the technique of chemically/physically introducing hydrophilic functional groups to the surfaces of pigment particles to thereby make the pigment particles capable of being dispersed and/or dissolved, for example, a technique may be used in which hydrophilic functional groups described below are introduced to the surfaces of pigment particles: —OM, —COOM, —CO—, —SO₃M, —SO₂NH₂, —RSO₂M, —PO₃HM, —PO₃M₂, —SO₂NHCOR, —NH₃, —NR₃, and the like. In these formulae, M represents a hydrogen atom, an alkaline metal, ammonium, or organic ammonium; and R represents an alkyl group having 1 to 12 carbon atoms, a phenyl group that may optionally have a substituent, or a naphthyl group that may optionally have a substituent. Such functional groups are physically and/or chemically introduced by being grafted to the surfaces of pigment particles directly and/or indirectly with multivalent groups connecting the functional groups and the surfaces. Examples of such a multivalent group include an alkylene group having 1 to 12 carbon atoms, a phenylene group that may optionally have a substituent, and a naphthylene group that may optionally have a substituent.

The surfaces of pigment particles are preferably treated with an agent containing sulfur such that —SO₃M and/or —RSO₂M (where M represents a counter ion: a hydrogen ion, an alkaline metal ion, an ammonium ion, or an organic ammonium ion) is chemically bonded to the surfaces. Specifically, the pigment particles are preferably made capable of being dispersed and/or dissolved in water by being dispersed in a solvent that does not have active protons, does not have reactivity with sulfonic acid, and allows no or slight dissolution of the pigment particles therein; and subsequently treating the surfaces of the pigment particles with amide sulfuric acid or a complex of sulfur trioxide and a tertiary amine such that —SO₃M and/or —RSO₂M is chemically bonded to the surfaces.

The surface-treatment of grafting the above-described functional groups or salts of the functional groups to the surfaces of pigment particles directly and/or indirectly with multivalent groups between the functional groups or the salts of the functional groups and the surfaces can be conducted by various known surface-treatment techniques. For example, such surface-treatment techniques are as follows: a technique of subjecting commercially available oxidized carbon black particles to ozone or a sodium hypochlorite solution to further oxidize the carbon black particles to thereby make the surfaces of the particles more hydrophilic (for example, JP-A-7-258578, JP-A-8-3498, JP-A-10-120958, JP-A-10-195331, or JP-A-10-237349); a technique of treating carbon black with 3-amino-N-alkyl-substituted pyridium bromide (for example, JP-A-10-195360, or JP-A-10-330665); a technique of dispersing organic pigment particles in a solvent that allows no or slight dissolution of the pigment therein and introducing sulfonic groups to the surfaces of the pigment particles with a sulfonating agent (for example, JP-A-8-283596, JP-A-10-110110, or JP-A-10-110111); and a technique of dispersing organic pigment particles in a basic solvent that can provide a complex with sulfur trioxide and adding sulfur trioxide to the solvent to thereby treat the surfaces of the pigment particles and introduce sulfonic groups or sulfonamino groups (for example, JP-A-10-110114). However, a technique for producing surface-treated pigment particles used for the invention is not restricted to these examples.

Such functional groups grafted to a pigment particle may be of one type or a plurality of types. The type(s) and the amount of functional groups to be grafted to pigment particles may be properly determined in consideration of the resultant properties such as the dispersion stability of the resultant pigment particles in ink, color density, or a drying property in the front surface of an ink jet head.

Examples of techniques of dispersing a pigment in water are described below. In the case of using a resin dispersing agent, a mixture of a pigment, water, and the resin dispersing agent is prepared. In the case of using a surfactant, a mixture of a pigment, water, and the surfactant is prepared. In the case of using a surface-treated pigment, a mixture of the pigment and water is prepared. If necessary, another agent such as a water-soluble organic solvent or a neutralizing agent may be added to each mixture. The pigments in these mixtures can be dispersed with a generally used dispersion apparatus such as a ball mill, a sand mill, an attritor, a roll mill, an agitator mill, a Henschel mixer, a colloid mill, an ultrasonic homogenizer, a jet mill, or an Angmill. In this case, to provide sufficiently high dispersion stability of a pigment in water, pigment particles are preferably dispersed so as to have an average particle diameter in the range of 20 to 500 nm, more preferably, in the range of 50 to 200 nm.

### 1. 1. 3. Water-Soluble Resin

A water-based ink composition used in a printing method according to the present embodiment further contains a water-soluble resin. One of the functions of such a water-soluble resin is to enhance the dispersibility of the above-described pigment. Another function of a water-soluble resin is, when a water-based ink composition is made adhere to a recording medium, to enhance the adhesion between the recording medium and the ink composition and/or the adhesion among solid contents in the ink composition. Examples of such a water-soluble resin include polyvinyl alcohols, polyvinyl pyrrolidones, polyacrylic acid, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-α-methyl styrene-acrylic acid copolymers, styrene-α-methyl styrene-acrylic acid-acrylate copolymers, styrene-maleic acid copolymers, styrene-maleic anhydride copolymers, vinylnaphthalene-acrylic acid copolymers, vinylnaphthalene-maleic acid copolymers, vinyl acetate-maleate copolymers, vinyl acetate-crotonic acid copolymers, vinyl acetate-acrylic acid copolymers, and salts of the foregoing. Among these examples, particularly preferred are copolymers produced with monomers having hydrophobic functional groups and monomers having hydrophilic functional groups; and polymers produced with monomers having both hydrophobic functional groups and hydrophilic functional groups. For the configuration of a copolymer, any one of a random copolymer, a block copolymer, an alternating copolymer, and a graft copolymer may be used.

The above-described salts are, for example, salts between the water-soluble resins and basic compounds such as ammonia, ethyl amine, diethylamine, triethylamine, propylamine, isopropylamine, dipropylamine, butylamine, isobutylamine, diethanolamine, triethanolamine, tri-iso-propanolamine, aminomethyl propanol, and morpholine. The amount of such a basic compound to be added is not particularly restricted as long as the amount is a neutralization equivalent or more for the above-described water-soluble resins.

The above-described water-soluble resins preferably have a weight-average molecular weight in the range of 1,000 to 100,000, more preferably, in the range of 3,000 to 10,000. When the molecular weight is in these ranges, for example, the following advantages are provided: a coloring agent is stably dispersed in water, and the viscosity of the resultant water-based ink composition can be readily adjusted. The above-described water-soluble resins preferably have an acid value in the range of 50 to 300, more preferably, in the range of 70 to 150. When the acid value is in these ranges, the following advantages are provided: the particles of a coloring agent can be stably dispersed in water, and a printed product produced by printing with a water-based ink composition containing such a water-soluble resin has good water resistance.

The above-described water-soluble resins may also be commercially available products. Specific examples of such products are JONCRYL 67 (weight-average molecular weight: 12,500, acid value: 213); JONCRYL 678 (weight-average molecular weight: 8,500, acid value: 215); JONCRYL 586 (weight-average molecular weight: 4,600, acid value: 108); JONCRYL 611 (weight-average molecular weight: 8,100, acid value: 53); JONCRYL 680 (weight-average molecular weight: 4,900, acid value: 215); JONCRYL 682 (weight-average molecular weight: 1,700, acid value: 238); JONCRYL 683 (weight-average molecular weight: 8,000, acid value: 160); and JONCRYL 690 (weight-average molecular weight: 16,500, acid value: 240), all of which are names of products manufactured by BASF Japan Ltd.

### 1. 1. 4. Thermoplastic Resin Particles

A water-based ink composition used in a printing method according to the present embodiment further contains thermoplastic resin particles. The thermoplastic resin particles function, in the second step described below, to solidify ink and strongly fix the solidified ink to a recording medium. As a result of this function, printed products produced by printing with a water-based ink composition containing such resin particles on recording media having no or low ink absorbency have excellent resistance to abrasion. A water-based ink composition used in a printing method according to the present embodiment may contain thermoplastic resin particles that completely dissolve in the water-based ink composition, or may contain thermoplastic resin particles to be in the state of being dispersed in the form of particles in the water-based ink composition (that is, an emulsion state or a suspension state).

Examples of a component for forming the thermoplastic resin particles include polyacrylates, copolymers of acrylates, polymethacrylates, copolymers of methacrylates, polyacrylonitrile, copolymers of acrylonitrile, polycyanoacrylate, polyacrylamide, polyacrylic acid, polymethacrylic acid, polyethylene, polypropylene, polybutene, polyisobutylene, polystyrene, copolymers of the foregoing, petroleum resins, chroman-indene resins, terpene resins, polyvinyl acetate, copolymers of vinyl acetate, polyvinyl alcohol, polyvinyl acetal, polyvinyl ether, polyvinyl chloride, copolymers of vinyl chloride, polyvinylidene chloride, fluorocarbon resins, fluorocarbon rubber, polyvinyl carbazole, polyvinyl pyrrolidone, copolymers of vinyl pyrrolidone, polyvinyl pyridine, polyvinyl imidazole, polybutadiene, copolymers of butadiene, polychloroprene, polyisoprene, and natural resins. Among these examples, particularly preferred are polymers having a molecular structure including both a hydrophobic portion and a hydrophilic portion.

Such thermoplastic resin particles may also be those obtained with known materials by known methods. For example, materials and methods described in JP-B-62-1426, JP-A-3-56573, JP-A-3-79678, JP-A-3-160068, and JP-A-4-18462 may be used. Alternatively, commercially available products may also be used as the thermoplastic resin particles. Examples of such products include: MICROGEL E-1002, MICROGEL E-5002 (both of which are names of products manufactured by Nippon Paint Co., Ltd.); VONCOAT 4001, VONCOAT 5454 (both of which are names of products manufactured by Dainippon Ink and Chemicals); SAE 1014 (name of a product manufactured by ZEON CORPORATION); Saivinol SK-200 (name of a product manufactured by Saiden Chemical Industry Co., Ltd.); JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, and JONCRYL 7610 (all of which are names of products manufactured by BASF Japan Ltd.).

The above-described thermoplastic resin particles can be obtained by any one of the following methods, or, if necessary, by combination of two or more methods among the following methods: a method of mixing monomers of a component for forming desired thermoplastic resin particles with a polymerization catalyst (polymerization initiator) and a dispersing agent and polymerizing the monomers (that is, emulsion polymerization is conducted); a method of dissolving a thermoplastic resin having a hydrophilic portion in a water-soluble organic solvent, mixing the resultant solution with water, and subsequently removing the water-soluble organic solvent by distillation or the like to provide thermoplastic resin particles; a method of dissolving a thermoplastic resin in a water-insoluble organic solvent, and mixing the resultant solution with a dispersing agent in an aqueous solution to provide thermoplastic resin particles; and the like. A method/methods for obtaining the above-described thermoplastic resin particles can be appropriately selected from the above-described methods in accordance with the type and characteristics of a thermoplastic resin to be used. A dispersing agent used for dispersing thermoplastic resin particles is not particularly restricted; however, examples of such a dispersing agent include anionic surfactants (for example, sodium dodecylbenzenesulfonate, sodium lauryl phosphate, and polyoxyethylene alkyl ether sulfate ammonium salt); and nonionic surfactants (for example, polyoxyethylene alkyl ethers, polyoxyethylene alkyl esters, polyoxyethylene sorbitan fatty acid esters, and polyoxyethylene alkyl phenyl ethers), and these examples may be used alone or as a mixture of two or more thereof.

A component for forming the above-described thermoplastic resin particles preferably contains at least one component having a glass transition temperature (hereinafter, referred to as Tg) of room temperature or more (generally, 30° C. or more). When thermoplastic resin particles contain a component having a Tg of room temperature or more, a strong resin film is formed in the second step described below and hence a printed product has good resistance to abrasion and the occurrence of ink clogging at the tips of nozzles of an ink jet head in an ink jet recording technique is reduced. In contrast, when thermoplastic resin particles are essentially composed of components having a Tg less than room temperature, a resin film formed often does not have sufficiently high strength and hence a printed product has poor resistance to abrasion, and ink solidifies at the tips of nozzles and ink clogging may tend to occur.

The content of thermoplastic resin particles in terms of solid content based on the entire amount of a water-based ink composition is preferably 0.1 to 15 mass %, more preferably, 0.5 to 10 mass %. When the content of thermoplastic resin particles is in these ranges, a water-based ink composition used in a printing method according to the present embodiment can be solidified and fixed even on recording media having no or low ink absorbency. When the content is less than 0.1 mass %, the strength of solidified and fixed ink is reduced and the ink may peel off from the surfaces of recording media. In contrast, when the content is more than 15 mass %, there is a possibility that the resultant water-based ink composition does not have sufficiently high storage stability or ejection stability.

### 1. 1. 5. Silicone-Based Surfactant

A water-based ink composition used in a printing method according to the present embodiment further contains a silicone-based surfactant. Such a silicone-based surfactant functions to spread the ink composition uniformly on recording media so as not to cause unevenness in ink density or blurring of ink. The content of such a silicone-based surfactant is preferably 0.1 to 1.5 mass % based on the entire amount of the water-based ink composition. When the content of a silicone-based surfactant is less than 0.1 mass %, it is difficult that undried ink spreads uniformly on recording media, which tends to result in unevenness in ink density or blurring of ink. In contrast, when the content of a silicone-based surfactant is more than 1.5 mass %, insoluble matter may remain or the storage stability of ink may be degraded. More preferably, the content of a silicone-based surfactant is 0.3 to 0.7 mass % based on the entire amount of the water-based ink composition.

Preferred examples of such a silicone-based surfactant are polysiloxane-based compounds such as polyether modified organosiloxanes. Specific examples of such a silicone-based surfactant are BYK-306, BYK-307, BYK-333, BYK-341, BYK-345, BYK-346, BYK-348 (all of which are names of products manufactured by BYK Japan KK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all of which are names of products manufactured by Shin-Etsu Chemical Co., Ltd.).

### 1. 1. 6. Acetylene Glycol-Based Surfactant

A water-based ink composition used in a printing method according to the present embodiment further contains an acetylene glycol-based surfactant. An acetylene glycol-based surfactant has excellent capability of appropriately maintaining surface tension and interfacial tension and has negligibly low foamability, which are advantageous when compared with other surfactants. For this reason, a water-based ink composition containing an acetylene glycol-based surfactant can appropriately maintain surface tension and the interfacial tension between ink and members of a printer being in contact with the ink such as the nozzle surface of an ink jet head. Thus, use of such a water-based ink composition for an ink jet recording technique enhances ejection stability. A water-based ink composition containing an acetylene glycol-based surfactant also exhibits good wettability and good permeability to recording media, and hence, high-resolution images having less unevenness in ink density and less blurring of ink can be provided. The content of such an acetylene glycol-based surfactant is preferably 0.1 to 1.0 mass % based on the entire amount of the water-based ink composition. When the content of an acetylene glycol-based surfactant is less than 0.1 mass %, it is difficult that undried ink spreads uniformly on recording media, which tends to result in unevenness in ink density or blurring of ink. In contrast, when the content of an acetylene glycol-based surfactant is more than 1.0 mass %, insoluble matter may remain or adhesion of an ink film may be reduced. More preferably, the content of an acetylene glycol-based surfactant is 0.2 to 0.5 mass % based on the entire amount of the water-based ink composition.

Examples of such an acetylene glycol-based surfactant include Surfynol 104, 104E, 104H, 104A, 104BC, 104DPM, 104PA, 104PG-50, 1045, 420, 440, 465, 485, SE, SE-F, 504, 61, DF37, CT111, CT121, CT131, CT136, TG, GA (all of which are names of products manufactured by Air Products and Chemicals, Inc.); OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, AE-3 (all of which are names of products manufactured by Nissin Chemical Industry Co., Ltd.); Acetylenol E00, E00P, E40, and E100 (all of which are names of products manufactured by Kawaken Fine Chemicals Co., Ltd.).

### 1. 1. 7. Penetrating Agent

A water-based ink composition used in a printing method according to the present embodiment further contains a penetrating agent. Such a penetrating agent functions synergistically with the above-described silicone-based surfactant and acetylene glycol-based surfactant to further enhance the wettability of a water-based ink composition to recording media to thereby provide uniform wetting. For this reason, addition of a penetrating agent to a water-based ink composition can further reduce unevenness in ink density or blurring of ink. The content of such a penetrating agent is 3 to 8 mass % based on the entire amount of the water-based ink composition. When the content of a penetrating agent is less than 3 mass %, the quality of printed images may be degraded or the occurrence of clogging of nozzles may be increased. In contrast, when the content of a penetrating agent is more than 8 mass %, a printed product may have degraded resistance to abrasion. More preferably, the total of the content of N-methyl-2-pyrrolidone, tetramethylurea, and dimethyl sulfoxide and the content of a penetrating agent is 15 mass % or less based on the entire amount of the water-based ink composition. This is because the total of the contents of more than 15 mass % may cause ink after printing to have a degraded drying property.

Examples of such a penetrating agent include glycol ethers, monovalent alcohols, and 1,2-alkyldiols.

Specific examples of the glycol ethers include: ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether.

Specific examples of the monovalent alcohols include water-soluble alcohols such as methanol, ethanol, n-propyl alcohol, iso-propyl alcohol, 2,2-dimethyl-1-propanol, n-butanol, 2-butanol, tert-butanol, iso-butanol, 2-methyl-1-butanol, 3-methyl-1-butanol, 3-methyl-2-butanol, n-pentanol, 2-pentanol, 3-pentanol, and tert-pentanol.

Specific examples of the 1,2-alkyldiols include 1,2-alkyldiols having 4 to 8 carbon atoms such as butanediol, pentanediol, hexanediol, heptanediol, and octanediol.

Among the above-described compounds, preferred penetrating agents are 1,2-alkyldiols having 6 to 8 carbon atoms such as 1,2-hexanediol, 1,2-heptanediol, and 1,2-octanediol. In particular, 1,2-hexanediol is preferred. Note that 1,2-hexanediol has a boiling point of about 223° C.

### 1. 1. 8. Moisture Retaining Agent

A water-based ink composition used in a printing method according to the present embodiment further contains a moisture retaining agent. One of the functions of such a moisture retaining agent is to suppress drying and solidification of ink in the nozzle surface of an ink jet head to thereby suppress clogging, ejection failure, and the like. Another function of a moisture retaining agent is to suppress evaporation of water in the water-based ink composition to thereby suppress aggregation and precipitation of solid matter such as a pigment or resin components in the ink. Such a moisture retaining agent preferably has a high vapor pressure. The reason why a moisture retaining agent preferably has a high vapor pressure is that the moisture retaining agent desirably evaporates together with water in the drying step (described below) for a water-based ink composition. The content of such a moisture retaining agent is 5 to 10 mass % based on the entire amount of the water-based ink composition. When the content of a moisture retaining agent is less than 5 mass %, the occurrence of clogging of nozzles may be increased. In contrast, when the content of a moisture retaining agent is more than 10 mass %, the drying rate of ink may be decreased, formation of a film of resin components may be inhibited, or the image quality of a printed product may be degraded. When the content of a moisture retaining agent is more than 10 mass %, solidification and fixing of ink on recording media are inhibited and the printed surfaces of printed products may peel off.

Examples of such a moisture retaining agent include glycerin, ethylene glycol, diethylene glycol, triethylene glycol, tetraethylene glycol, polyethylene glycol, propylene glycol, dipropylene glycol, 1,3-propanediol, 1,4-butanediol, polypropylene glycol, 1,5-pentanediol, 2,3-butanediol, 2-methyl-2,4-pentanediol, 2-ethyl-1,3-hexanediol, 1,2,6-hexanetriol, pentaerythritol, 1,6-hexanediol, 1,8-octanediol, 2,2-dimethyl-1,3-propanediol, 2,2-diethyl-1,3-propanediol, trimethylolethane, trimethylolpropane, urea, 2-imidazolidinone, thiourea, and 1,3-dimethyl-2-imidazolidinone. Among these examples, in view of high vapor pressure and not degrading the drying property of a water-based ink composition after printing, preferred are ethylene glycol, diethylene glycol, propylene glycol, and dipropylene glycol; and particularly preferred is propylene glycol. Note that propylene glycol has a boiling point of 188° C.

### 1. 1. 9. Water

A water-based ink composition used in a printing method according to the present embodiment further contains water. Water serves as a main medium in the water-based ink composition and evaporates in the drying step described below.

Such water is preferably pure water or ultrapure water obtained by minimizing ionic impurities, such as ion-exchanged water, ultrafiltered water, reverse osmosis water, or distilled water. Use of water sterilized by ultraviolet irradiation, addition of hydrogen peroxide, or the like is preferred because the resultant pigment dispersions or water-based ink compositions containing such pigment dispersions can be stored for a long period of time without generation of fungi or bacteria.

### 1. 1. 10. Other Additive Components

As described above, a water-based ink composition used in a printing method according to the present embodiment at least contains at least one selected from N-methyl-2-pyrrolidone, tetramethylurea, and dimethyl sulfoxide; a coloring agent; a water-soluble resin; thermoplastic resin particles; a silicone-based surfactant; an acetylene glycol-based surfactant; a penetrating agent; a moisture retaining agent; and water. Use of such a water-based ink composition can provide recorded products having less unevenness in ink density and less blurring of ink and excellent resistance to abrasion even when images are recorded on plastic films. To enhance these advantages, a water-based ink composition may further contain an additive component such as a pH adjusting agent, a preservative/fungicide, a rust inhibitor, or a chelating agent.

Examples of such a pH adjusting agent include potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, and sodium acid carbonate.

Examples of such a preservative/fungicide include sodium benzoate, sodium pentachlorophenol, sodium 2-pyridinethiol-1-oxide, sodium sorbate, sodium dehydroacetate, and 1,2-dibenzynethiazoline-3-one. Commercially available products of such a preservative/fungicide are, for example, Proxel XL2, Proxel GXL (both of which are names of products manufactured by Avecia Limited); Denicide CSA, and NS-500W (both of which are names of products manufactured by Nagase ChemteX Corporation).

An example of such a rust inhibitor is benzotriazole.

Examples of such a chelating agent include ethylenediaminetetraacetic acid and salts of ethylenediaminetetraacetic acid (dihydrogen disodium ethylenediaminetetraacetate and the like).

### 1. 1. 11. Properties of Water-Based Ink Composition

A water-based ink composition used in a printing method according to the present embodiment preferably has a neutral or alkaline pH, more preferably, a pH in the range of 7.0 to 10.0. When a water-based ink composition has an acidic pH, the ink composition may have degraded storage stability and degraded dispersion stability, and disadvantages such as corrosion of metal parts used for ink passages in an ink jet recording apparatus tends to be caused. A water-based ink composition can be adjusted to have a neutral or alkaline pH with the above-described pH adjusting agent.

Such a water-based ink composition preferably has a viscosity in the range of 1.5 to 15 mPa·s at 20° C. When the viscosity is in this range, sufficiently high ink ejection stability can be provided in the first step described below.

Such a water-based ink composition preferably has a surface tension of 20 to 40 mN/m, more preferably, 25 to 35 mN/m, at 25° C. When the surface tension is in these ranges, sufficiently high ink ejection stability can be provided in the first step described below, and appropriate wettability of ink to recording media having no or low ink absorbency can be provided.

### 1. 1. 12. Method for Producing Water-Based Ink Composition

A water-based ink composition used in a printing method according to the present embodiment can be produced by mixing the above-described materials in a desired sequence and, if necessary, removing impurities from the resultant mixture by filtration or the like. In this production, in view of ease of handling or the like, the coloring agent and the water-soluble resin are preferably prepared so as to be uniformly dispersed and subsequently mixed with other materials.

The materials are preferably mixed by sequentially adding the materials into a vessel including a stirring device such as a mechanical stirrer or a magnetic stirrer, and stirring the added materials. If necessary, the resultant mixture can be filtrated by centrifugal filtration, filter filtration, or the like.

### 1. 2. Printing Steps

Hereinafter, steps of a printing method employing an ink jet recording technique according to the present embodiment will be described in detail.

### 1. 2. 1. First Step

The first step of a printing method according to the present embodiment is a step of forming an image with an ink jet recording technique by ejecting droplets of the above-described water-based ink composition onto a recording medium having no or low ink absorbency.

In the first step, any ink jet recording technique may be used as long as, in the technique, the above-described water-based ink composition is ejected as droplets through a fine nozzle so that the droplets are made adhere to a recording medium. For example, four ink jet recording techniques are described below.

The first technique is referred to as an electrostatic suction technique in which a strong electric field is applied between a nozzle and an accelerating electrode positioned in front of the nozzle, ink is continuously ejected from the nozzle in the form of droplets, and printing data signals are provided to deflection electrodes while the ink droplets fly between the deflection electrodes to thereby conduct recording; or the ink droplets are ejected in accordance with printing data signals without deflecting the ink droplets.

The second technique is to forcibly eject ink droplets by applying pressure to ink liquid with a small pump and mechanically vibrating a nozzle with a quartz vibrator or the like. The ink droplets being ejected are simultaneously electrically charged and printing data signals are provided to deflection electrodes while the ink droplets fly between the deflection electrodes to thereby conduct recording.

The third technique employs a piezoelectric element in which pressure and printing data signals are simultaneously applied to ink liquid with the piezoelectric element to eject ink droplets to thereby conduct recording.

The fourth technique is to abruptly increase the volume of ink liquid with thermal energy in which the ink liquid is heated and foamed with a microelectrode in accordance with printing data signals to eject ink droplets to thereby conduct recording.

As for recording media, recording media having no or low ink absorbency are used. Examples of recording media having no ink absorbency include plastic films that are not subjected to a surface treatment for ink jet printing (that is, ink absorption layers are not formed); recording media in which a substrate such as a paper sheet is coated with plastic; and recording media in which a plastic film is bonded to a substrate such as a paper sheet. Herein, the term “plastic” refers to, for example, polyvinyl chloride, polyethylene terephthalate, polycarbonate, polystyrene, polyurethane, polyethylene, or polypropylene. Examples of recording media having low ink absorbency include coated printing papers such as art paper, coated paper, and matte paper.

Herein, the term “recording media having no or low ink absorbency” refers to recording media having a printing surface that absorbs 10 mL/m² or less water from the initial contact with water until when 30 msec^{1/2} has elapsed under the measurement of the Bristow method. The Bristow method is most commonly used for measuring the amount of liquid absorbed in a short period of time and is also used in Japan Technical Association of the Pulp and Paper Industry (JAPAN TAPPI). This test method is described in detail in Standard No. 51 “Paper and Paperboard-Liquid Absorbency Test Method-Bristow Method” in “JAPAN TAPPI Paper and Pulp Test Methods 2000 Edition”.

### 1. 2. 2. Second Step

A printing method according to the present embodiment includes the second step of drying the above-described water-based ink composition on a recording medium, the second step being conducted so as to at least overlap the above-described first step. By conducting the second step so as to overlap the first step, water contained in the water-based ink composition adhering to a recording medium can be rapidly evaporated substantially concurrently with the first step. As a result, high quality images having less unevenness in ink density and less blurring of ink and having good resistance to abrasion can be provided even when the images are printed on recording media having no ink absorbency such as plastic films without an ink absorption layer.

The reasons why these advantages can be obtained are as follows. In the first step, the above-described water-based ink composition upon being made adhere to a recording medium having no or low ink absorbency is not absorbed by the recording medium and is in the form of droplets. In this state, disadvantages may be caused, for example, coalescence of adjacently positioned droplets causes the size increase of the droplets or undesired mixing of compositions. However, when the second step is conducted concurrently with the first step, the amount of liquid components contained in the water-based ink composition is rapidly reduced upon adhesion of the water-based ink composition to a recording medium. At this time, at least one selected from N-methyl-2-pyrrolidone, tetramethylurea, and dimethyl sulfoxide; a penetrating agent; and a moisture retaining agent have boiling points higher than the boiling point of water, and hence, the amount of water is reduced faster than the amounts of these other components.

Thus, the amount of liquid components in droplets is reduced; and the relative amount of water in the liquid components in droplets is reduced and the concentration of at least one selected from N-methyl-2-pyrrolidone, tetramethylurea, and dimethyl sulfoxide in the composition of the liquid components in droplets increases, and hence, the solubility of thermoplastic resin particles increases. This contributes to an increase in the viscosity of the water-based ink composition forming the droplets. As a result, the rate of the size increase of droplets, the rate of undesired mixing of compositions of droplets, and the like can be decreased.

Additionally, by increasing the concentration of at least one selected from N-methyl-2-pyrrolidone, tetramethylurea, and dimethyl sulfoxide in the composition of droplets, the effect of swelling or softening thermoplastic resin particles is enhanced, and the effect of solidifying ink containing thermoplastic resin particles and fixing solidified ink onto recording media can be enhanced.

The second step is not particularly restricted as long as a process of promoting evaporation of liquid media in a water-based ink composition is conducted. An example of a process/processes conducted in the second step is a process of applying heat to a recording medium so as to overlap the first step, a process of blowing air to a water-based ink composition on a recording medium so as to overlap the first step, or combination of these processes. Specifically, preferred processes are forced-air heating, radiation heating, conduction heating, high frequency drying, microwave heating, and the like.

A water-based ink composition, as a result of the application of heat in the second step, needs to be brought to a temperature range in which evaporation of liquid components in the water-based ink composition can be promoted. This is achieved in the region of 40° C. or more, preferably in the range of 40° C. to 80° C., and more preferably in the range of 40° C. to 60° C. When the temperature is more than 80° C., for example, disadvantages may be caused in which recording media of a type are deformed and the recording media are not properly conveyed after the second step, or recording media of a type undesirably shrink when cooled to room temperature.

Heating time in the second step is not particularly restricted as long as a desired amount of liquid components in a water-based ink composition can be evaporated in the heating. The heating time may be properly selected in consideration of conditions such as liquid components used, resin components used, printing speed, or drying efficiency.

In the second step, the entire liquid components in a water-based ink composition may be removed, or part of the liquid components may be remained. Although the second step is conducted so as to overlap the first step, subsequently, one or more second steps may be further conducted. After the second step is conducted, the resultant printed products may be dried by another process; for example, the printed products may be dried in the air at room temperature.

Use of the printing method employing an ink jet recording technique according to the present embodiment having been described so far can provide high quality images having less blurring of ink and excellent resistance to abrasion.

### 2. Examples and Comparative Examples

Hereinafter, the invention is described in detail with reference to Examples and Comparative Examples. However, the invention is not restricted to these Examples. Note that the term “part” in the following description refers to “part by mass”.

### 2. 1. Preparation of Water-Based Ink Compositions

### 2. 1. 1. Preparation of Pigment Dispersions

Each water-based ink composition used in Examples contained a water-insoluble pigment serving as a coloring agent. Such a pigment was dispersed in a water-soluble resin and subsequently added to each water-based ink composition.

Each pigment dispersion was prepared in the following manner. First, 3 parts by mass of an acrylic acid-acrylate copolymer (weight-average molecular weight: 25,000, acid value: 180) serving as a water-soluble resin were added to and dissolved in 84.4 parts by mass of ion-exchanged water in which 0.6 parts by mass of 30% aqueous ammonia (neutralizing agent) were dissolved. The resultant solution was mixed with 12 parts by mass of one of the pigments described below and subjected to a dispersion treatment with a ball mill containing zirconia beads for 10 hours. After that, the resultant solution was subjected to centrifugal filtration with a centrifuge to remove impurities such as coarse particles and foreign particles. The resultant solution was adjusted to have a pigment concentration of 12 mass %. The pigments used for producing the above pigment dispersions are as follows.

C.I. Pigment Black 7 (used for Black Pigment Dispersion 1)

C.I. Pigment Yellow 74 (used for Yellow Pigment Dispersion)

C.I. Pigment Red 122 (used for Magenta Pigment Dispersion)

C.I. Pigment Blue 15:3 (used for Cyan Pigment Dispersion)

C.I. Pigment Orange 43 (used for Orange Pigment Dispersion)

C.I. Pigment Green 36 (used for Green Pigment Dispersion)

### 2. 1. 2. Preparation of Water-Based Ink Compositions and Ink Sets

The pigment dispersions prepared in “2. 1. 1. Preparation of pigment dispersions” above were used to prepare ink sets each constituted by six water-based ink compositions (black, yellow, magenta, cyan, orange, and green) having material compositions shown in Table 1 below. Thus, Ink sets 1 to 14 having different compositions were prepared. Specifically, each water-based ink composition was prepared by charging materials shown in Table 1 into a vessel, mixing the materials with a magnetic stirrer for 2 hours, and subsequently filtrating the resultant mixture through a membrane filter having a pore size of 5 μm to thereby remove impurities such as foreign particles or coarse particles. Note that all the values in Table 1 are given in mass %. Ion-exchanged water was added such that the material compositions shown in Table 1 were ultimately achieved.

TABLE 1
Unit: mass %

| | | Ink set | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| N-methyl-2-pyrrolidone | | 10.0 | 3.0 | — | — | 8.0 | 5.0 | 15.0 | 1.0 | 10.0 | 10.0 | 10.0 | 5.0 | — | 10.0 |
| Tetramethylurea | | — | — | 6.0 | — | — | — | — | — | — | — | — | — | — | — |
| Dimethyl sulfoxide | | — | — | — | 6.0 | — | — | — | — | — | — | — | — | — | — |
| 2-pyrrolidone | | — | — | — | — | — | — | — | — | — | — | — | — | 6.0 | — |
| Water-insoluble coloring | | 4.0 | 4.0 | 4.0 | 4.0 | 4.0 | 4.0 | 4.0 | 4.0 | 4.0 | 4.0 | 4.0 | 4.0 | 4.0 | 4.0 |
| agent | | | | | | | | | | | | | | | |
| Water-soluble | Acrylic | 1.0 | 1.0 | 1.0 | 1.0 | 1.0 | 1.0 | 1.0 | 1.0 | 1.0 | 1.0 | 1.0 | 1.0 | 1.0 | 1.0 |
| resin | acid- | | | | | | | | | | | | | | |
| | acrylate | | | | | | | | | | | | | | |
| | copolymer | | | | | | | | | | | | | | |
| Thermoplastic | Styrene- | 1.5 | 1.5 | 1.5 | 1.5 | 1.5 | 1.5 | 1.5 | 1.5 | 1.5 | 1.5 | 1.5 | 1.5 | 1.5 | 1.5 |
| resin particles | acrylic acid | | | | | | | | | | | | | | |
| | copolymer | | | | | | | | | | | | | | |
| Silicone- | BYK348 | 0.5 | 0.5 | 0.5 | 0.5 | 0.5 | 0.5 | 0.5 | 0.5 | 0.5 | 0.5 | 0.5 | 0.5 | 0.5 | 0.5 |
| based | | | | | | | | | | | | | | | |
| surfactant | | | | | | | | | | | | | | | |
| Acetylene | Surfynol | 0.5 | 0.5 | 0.5 | 0.5 | 0.5 | 0.5 | 0.5 | 0.5 | 0.5 | 0.5 | 0.5 | 0.5 | 0.5 | 0.5 |
| glycol-based | 104-PG-50 | | | | | | | | | | | | | | |
| surfactant | | | | | | | | | | | | | | | |
| Penetrating | 1,2- | 5.0 | 8.0 | 8.0 | 8.0 | 6.0 | 8.0 | 5.0 | 5.0 | 5.0 | 5.0 | 2.0 | 10.0 | 6.0 | — |
| agent | hexanediol | | | | | | | | | | | | | | |
| Moisture | Propylene | 5.0 | 10.0 | 6.0 | 6.0 | 6.0 | 8.0 | 2.0 | 15.0 | 3.0 | 12.0 | 5.0 | 5.0 | — | — |
| retaining | glycol | | | | | | | | | | | | | | |
| agent | Diethylene | — | — | — | — | — | — | — | — | — | — | — | — | 4.0 | 7.0 |
| | glycol | | | | | | | | | | | | | | |
| | Dipropylene | — | — | — | — | — | — | — | — | — | — | — | — | 5.0 | — |
| | glycol | | | | | | | | | | | | | | |
| Water | Ion- | Re- | Re- | Re- | Re- | Re- | Re- | Re- | Re- | Re- | Re- | Re- | Re- | Re- | Re- |
| | exchanged | main- | main- | main- | main- | main- | main- | main- | main- | main- | main- | main- | main- | main- | main- |
| | water | der | der | der | der | der | der | der | der | der | der | der | der | der | der |

As shown in Table 1, for the thermoplastic resin particles, a styrene-acrylic acid copolymer was used. For the penetrating agent, 1,2-hexanediol was used. For the moisture retaining agent, propylene glycol, diethylene glycol, or dipropylene glycol was used. “BYK-348” used as the silicone-based surfactant is the name of a product manufactured by BYK Japan KK. “Surfynol 104-PG-50” used as the acetylene glycol-based surfactant is the name of a product manufactured by Nissin Chemical Industry Co., Ltd. As for Ink set 13, 2-pyrrolidone was used instead of at least one selected from N-methyl-2-pyrrolidone, tetramethylurea, and dimethyl sulfoxide.

### 2. 1. 3. Preparation of Evaluation Samples

Recording media used were cold lamination film PG-50L (product name; manufactured by Lami Corporation Inc.; hereafter, referred to as PET Film), which is polyethylene terephthalate films having no ink absorbency; and OK Topkote Plus (product name; manufactured by Oji Paper Co., Ltd.; hereafter, referred to as OK Top), which is gloss-type light-coated paper having low ink absorbency.

A printer employing an ink jet recording technique used was an ink jet printer PX-G930 (product name, manufactured by SEIKO EPSON CORPORATION, nozzle resolution: 180 dpi) that was modified such that a variable temperature heater was attached to the paper guide part of the printer.

One of Ink sets was charged into the ink jet printer PX-G930 and printing was conducted with this printer onto the recording media. The printing was conducted under three conditions in which the heater in the printer was set at 35° C., 40° C., and 50° C. Determination of the temperatures of the surfaces of recording media in the vicinity of the printing head of the printer during printing revealed that the temperatures were substantially the same as the temperatures set for the heater under all the three conditions.

In this way, such printing was conducted under the three temperature conditions with each Ink set to prepare evaluation samples of Examples 1 to 12 and Comparative Examples 1 to 30 in Table 2 below.

TABLE 2

| Examples | | 1 | 2 | 3 | 4 | 5 | 6 |
|---|---|---|---|---|---|---|---|
| Ink set No. | | 1 | 2 | 3 | 4 | 5 | 6 |
| Temperature (° C.) in Second step | | 50 | 50 | 50 | 50 | 50 | 50 |
| Image | PET Film | Good | Excellent | Excellent | Excellent | Excellent | Excellent |
| quality | OK Top | Good | Excellent | Excellent | Excellent | Excellent | Excellent |
| Abrasion resistance | | Good | Good | Good | Good | Good | Good |
| Anti-clogging property | | Good | Good | Good | Good | Good | Good |
| Examples | | 7 | 8 | 9 | 10 | 11 | 12 |
| Ink set No. | | 1 | 2 | 3 | 4 | 5 | 6 |
| Temperature (° C.) in Second step | | 40 | 40 | 40 | 40 | 40 | 40 |
| Image | PET Film | Good | Good | Good | Good | Good | Good |
| quality | OK Top | Good | Good | Good | Good | Excellent | Excellent |
| Abrasion resistance | | Good | Good | Good | Good | Good | Good |
| Anti-clogging property | | Good | Good | Good | Good | Good | Good |
| Comparative Examples | | 1 | 2 | 3 | 4 | 5 | 6 |
| Ink set No. | | 1 | 2 | 3 | 4 | 5 | 6 |
| Temperature (° C.) in Second step | | 35 | 35 | 35 | 35 | 35 | 35 |
| Image | PET Film | Poor | Poor | Poor | Poor | Poor | Poor |
| quality | OK Top | Poor | Poor | Poor | Poor | Poor | Poor |
| Abrasion resistance | | Good | Good | Good | Good | Good | Good |
| Anti-clogging property | | Good | Good | Good | Good | Good | Good |
| Comparative Examples | | 7 | 8 | 9 | 10 | 11 | 12 |
| Ink set No. | | 7 | 8 | 9 | 10 | 11 | 12 |
| Temperature (° C.) in Second step | | 50 | 50 | 50 | 50 | 50 | 50 |
| Image | PET Film | Good | Good | Good | Poor | Poor | Excellent |
| quality | OK Top | Good | Good | Good | Good | Poor | Excellent |
| Abrasion resistance | | Good | Poor | Good | Good | Good | Poor |
| Anti-clogging property | | Poor | Good | Poor | Good | Poor | Good |
| Comparative Examples | | 13 | 14 | 15 | 16 | 17 | 18 |
| Ink set No. | | 13 | 14 | 7 | 8 | 9 | 10 |
| Temperature (° C.) in Second step | | 50 | 50 | 40 | 40 | 40 | 40 |
| Image | PET Film | Good | Poor | Good | Good | Good | Poor |
| quality | OK Top | Good | Poor | Good | Good | Good | Good |
| Abrasion resistance | | Poor | Good | Good | Poor | Good | Good |
| Anti-clogging property | | Good | Good | Poor | Good | Poor | Good |
| Comparative Examples | | 19 | 20 | 21 | 22 | 23 | 24 |
| Ink set No. | | 11 | 12 | 13 | 14 | 7 | 8 |
| Temperature (° C.) in Second step | | 40 | 40 | 40 | 40 | 35 | 35 |
| Image | PET Film | Poor | Good | Poor | Poor | Poor | Poor |
| quality | OK Top | Poor | Good | Poor | Poor | Poor | Poor |
| Abrasion resistance | | Good | Poor | Poor | Good | Good | Poor |
| Anti-clogging property | | Poor | Good | Good | Good | Good | Good |
| Comparative Examples | | 25 | 26 | 27 | 28 | 29 | 30 |
| Ink set No. | | 9 | 10 | 11 | 12 | 13 | 14 |
| Temperature (° C.) in Second step | | 35 | 35 | 35 | 35 | 35 | 35 |
| Image | PET Film | Poor | Poor | Poor | Poor | Poor | Poor |
| quality | OK Top | Poor | Poor | Poor | Poor | Poor | Poor |

| | | | | | | |
|---|---|---|---|---|---|---|
| Abrasion resistance | Good | Good | Good | Poor | Poor | Good |
| Anti-clogging property | Good | Good | Poor | Good | Good | Good |

### 2. 2. Evaluation of Printing

### 2. 2. 1. Evaluation of Image Quality

Two adjacent patterns having different colors were printed in a lateral resolution of 720 dpi and a longitudinal resolution of 720 dpi and the amount of ink used in this printing was varied among Examples and Comparative Examples. The presence or absence of blurring of ink at the boundary of the two adjacent patterns was determined. The following different criteria were used depending on the type of recording media. The evaluation results are shown in Table 2.

### PET Film

Excellent: The amount of ink used in the printing was 1.6 mg/cm² and no blurring was observed.

Good: The amount of ink used in the printing was 1.4 mg/cm² and no blurring was observed.

Poor: The amount of ink used in the printing was 1.4 mg/cm² and blurring was observed.

### OK Top

Excellent: The amount of ink used in the printing was 2.0 mg/cm² and no blurring was observed.

Good: The amount of ink used in the printing was 1.8 mg/cm² and no blurring was observed.

Poor: The amount of ink used in the printing was 1.8 mg/cm² and blurring was observed.

### 2. 2. 2. Evaluation of Abrasion Resistance

Each printed product formed with a PET film was heated in a thermostatic oven at 70° C. for 10 minutes, and subsequently dried at room temperature for 24 hours. The printed surface of the thus-dried printed product was rubbed 50 times with shirting under a load of 500 g in a Gakushin-Type Color Fastness Rubbing Tester, and the presence or absence of scratches on the printed surface was determined. This evaluation was conducted in accordance with the following criteria and the evaluation results are shown in Table 2.

Good: No scratch exposing the substrate was observed.

Poor: Scratches exposing the substrate were observed.

### 2. 2. 3. Evaluation of Anti-Clogging Property

Solid patterns were continuously printed on 100 A4-size sheets of the recording media with each Ink set using 0.3 mg/cm² of ink under the above-described temperature conditions. The printed product of each 100th sheet was observed and the presence or absence of missing dots or misplaced dots was determined. This evaluation was conducted in accordance with the following criteria and the evaluation results are shown in Table 2.

Good: No missing dots nor misplaced dots were observed.

Poor: Missing dots or misplaced dots were observed.

### 2. 3. Evaluation Results

Examples 1 to 12 provided good results in terms of image quality, abrasion resistance, and the anti-clogging property. As shown in Table 1, Examples 1 to 12 employed Ink sets 1 to 6 in which a water-based ink composition contained at least one selected from N-methyl-2-pyrrolidone, tetramethylurea, and dimethyl sulfoxide; a water-insoluble coloring agent; a water-soluble resin; thermoplastic resin particles; a silicone-based surfactant; an acetylene glycol-based surfactant; a penetrating agent; a moisture retaining agent; and water, the total content of the N-methyl-2-pyrrolidone, the tetramethylurea, and the dimethyl sulfoxide in the water-based ink composition was 3.0 to 10.0 mass, the content of the penetrating agent in the water-based ink composition was 3.0 to 8.0 mass %, and the content of the moisture retaining agent in the water-based ink composition was 5.0 to 10.0 mass %. As shown in Table 2, in Examples 1 to 12, the temperature of the second step, that is, the temperature of the heater of the printer was set at 40° C. or 50° C.

In contrast, Comparative Examples 1 to 6 provided printed products having blurring and poor image quality. In Comparative Examples 1 to 6, Ink sets 1 to 6 were used and the temperature of the second step, that is, the temperature of the heater of the printer was set at 35° C.

Ink sets 7 to 14 included at least one component that did not satisfy the above-described composition ranges or did not include one or more indispensable components. Use of Ink sets 7 to 14 provided at least one poor result in terms of image quality, abrasion resistance, and the anti-clogging property regardless of the temperature of the second step (Comparative Examples 7 to 30).

In summary, it has been confirmed that the printing methods according to Examples 1 to 12 permit formation of images on recording media having no or low ink absorbency, the images being of high quality, having less blurring of ink and excellent resistance to abrasion. It has also been confirmed that use of the printing methods according to Examples 1 to 12 reduces the occurrence of clogging of the nozzles of a printer.

The invention is not restricted to the above-described embodiments and various modifications can be made. For example, the invention embraces configurations substantially the same as the configurations described in the embodiments. Stated another way, the invention embraces, for example, configurations having the same functions, methods, and results, or the same object and advantages as in the configurations described in the embodiments. The invention also embraces configurations obtained by replacing, in the configurations described in the embodiments, a feature/features that are not indispensable. The invention also embraces configurations that provide the same functions and advantages as in the configurations described in the embodiments, and configurations that achieve the same object as in the configurations described in the embodiments. The invention also embraces configurations obtained by combining the configurations described in the embodiments with a known technique/techniques.

What is claimed is:

1. A printing method employing an ink jet recording technique comprising:
forming an image with an ink jet recording technique by ejecting droplets of a water-based ink composition onto a recording medium having no or low ink absorbency; and
drying the water-based ink composition on the recording medium, the drying being conducted so as to at least overlap the forming,
wherein the water-based ink composition contains at least one selected from N-methyl-2-pyrrolidone, tetramethylurea, and dimethyl sulfoxide; a water-insoluble coloring agent; a water-soluble resin; thermoplastic resin particles; a silicone-based surfactant; an acetylene glycol-based surfactant; a penetrating agent; a moisture retaining agent; and water,
a total content of the N-methyl-2-pyrrolidone, the tetramethylurea, and the dimethyl sulfoxide in the water-based ink composition is 3.0 to 10.0 mass %,
a content of the penetrating agent in the water-based ink composition is 3.0 to 8.0 mass %, and
a content of the moisture retaining agent in the water-based ink composition is 5.0 to 10.0 mass %.

2. The printing method employing an ink jet recording technique according to claim 1, wherein the drying includes at least one of heating the recording medium to the range of 40° C. to 80° C. and blowing air in the range of 40° C. to 80° C. to the water-based ink composition on the recording medium.

3. The printing method employing an ink jet recording technique according to claim 1, wherein the thermoplastic resin particles swell or dissolve in at least one selected from N-methyl-2-pyrrolidone, tetramethylurea, and dimethyl sulfoxide serving as a solvent.

4. The printing method employing an ink jet recording technique according to claim 1, wherein the penetrating agent is 1,2-hexanediol.

5. The printing method employing an ink jet recording technique according to claim 1, wherein the moisture retaining agent is propylene glycol.

6. The printing method employing an ink jet recording technique according to claim 1, wherein the water-based ink composition has a viscosity in the range of 1.5 to 15 mPa·s at 20° C.

7. The printing method employing an ink jet recording technique according to claim 1, wherein a content of the silicone-based surfactant in the water-based ink composition is 0.1 to 1.5 mass %.

8. The printing method employing an ink jet recording technique according to claim 1, wherein a content of the acetylene glycol-based surfactant in the water-based ink composition is 0.1 to 1.0 mass %.
